(19) United States
(12) Patent Application Publication
(10) Pub. No.: US 2009/0236858 A1
(43) Pub. Date: Sep. 24, 2009

(54) VERTICAL TURBINE FOR WATER OR WIND POWER GENERATION

(76) Inventor: Larry Johnson, Wellington, FL (US)

Correspondence Address: ITALIA IP, 3500 WEST OLIVE AVE., SUITE 300, BURBANK, CA, 91505, US

(21) Appl. No.: 12/269,176

(22) Filed: Nov. 12, 2008

Related U.S. Application Data
(60) Provisional application No. 61/038,628, filed on Mar. 21, 2008.

(51) Int. Cl. F03B 13/10; F03D 3/00

(52) U.S. Cl. 290/55; 290/52

(57) ABSTRACT

A vertical turbine system comprising includes a turbine having a vertical rotational shaft, a pair of oppositely disposed circular frame members radially affixed to the shaft, and a plurality of vanes having a generally rectangular profile, each vane rotatably affixed to the circular frame members at the ends of its leading edge, with rotation of the vanes about the leading edge limited to a maximum of about 40° to about 80°. A generator is operatively connected to one end of the shaft for converting rotational energy of the shaft into electrical energy, the lower end of the shaft is affixed to a ground surface, and the generator is maintained in a generally stationary position as the turbine rotates about the shaft. The vertical turbine system can be adapted for wind or water use.

### CROSS-REFERENCE TO RELATED APPLICATION

This application claims the benefit of the filing date under 35 USC 119(e) of U.S. Provisional Application Ser. No. 61/038,628, filed Mar. 21, 2008, the contents of which are incorporated herein by reference.

### BACKGROUND OF INVENTION

This application relates generally to ocean current, tidal or wind power generation. More specifically, this application relates to a vertical turbine with movable blades or sails for harnessing the kinetic energy of a moving fluid and converting it into useful electrical energy.

### SUMMARY

Conventional turbine systems for harnessing kinetic energy of moving fluids, such as wind or water, and converting that kinetic energy into electrical energy, are well known, generally comprising fixed blade turbines, limiting the range over which the blade provides power to the system, the placement of the turbine system in the fluid stream, and the type of fluid stream the system can be utilized in. The present invention is a vertical turbine system having blades or sails which are pivotable about an axis formed by their leading edge as the turbine rotates about its shaft. These pivoting blades or sails allow them to provide power over a larger portion of the circumference of the turbine as it rotates, allow the turbine to develop power no matter what direction the flow of fluid through it is, and enable the system to function is water or air. Described herein is a vertical turbine system for generating power from a fluid stream that is easy to use and solves the problems mentioned above. The device is of simple construction, inexpensive to produce, economical to maintain, and can be used in conjunction with all forms of electrical systems.

In particular, this application discloses a vertical turbine system employing a turbine having a vertical rotational shaft with upper end lower ends, a pair of oppositely disposed circular frame members radially affixed to the shaft, rectangular vanes having a pair of distal ends, a leading edge and a trailing edge, with each vane rotatably affixed to the circular frame members at the ends of their leading edge, and means for limiting rotation of the vanes to a maximum of about 40° to about 80°. The vertical turbine system of the present invention also has a generator operatively connected to one end of the shaft for converting rotational energy of the shaft into electrical energy, anchoring means for affixing the lower end of the shaft to a ground surface, and torque control means for maintaining the generator in a generally stationary position as the turbine rotates about the shaft.

This application also discloses a vertical turbine system employing a turbine having a vertical rotational shaft with upper end lower ends, a pair of oppositely disposed circular frame members radially affixed to the shaft, rectangular sails having a pair of distal ends, a leading edge and a trailing edge, each sail rotatably affixed to the circular frame members at the ends of its leading edge, and a tether connecting the trailing edge of each end of the sails to one of the circular frame members for limiting rotation of the sails to a maximum of about 40° to about 80°. The vertical turbine system of the present invention also has: anchoring means for affixing the lower end of the shaft to a ground surface, the anchoring means including a cylindrical bore through the center of the shaft, a vertical support pole securable to a terrestrial ground surface, the vertical support pole sized to fit within the cylindrical bore, and bearing means for allowing free rotation of the shaft about the vertical support pole; a generator affixed to the vertical support pole; a ring gear affixed to the lower end of the shaft; and a drive gear integral to the generator, the drive gear sized to matingly engage the ring gear to transmit rotational energy of the shaft to the generator for converting rotational energy of the shaft into electrical energy.

This application further a method of generating electrical energy from a moving fluid stream comprising the steps: providing a vertical turbine system including a turbine having a vertical rotational shaft with upper and lower ends, a pair of oppositely disposed circular frame members radially affixed to the shaft, generally rectangular vanes having a pair of distal ends, a leading edge and a trailing edge, each vane rotatably affixed to the circular frame members at the ends of its leading edge, and means for limiting rotation of the vanes to a maximum of about 60°, a generator operatively connected to one end of the shaft for converting rotational energy of the shaft into electrical energy, anchoring means for affixing the lower end of the shaft to a ground surface, and torque control means for maintaining the generator in a generally stationary position as the turbine rotates about the shaft; and anchoring the vertical turbine system to a ground surface with the turbine in a moving fluid stream such that the moving fluid stream causes the turbine to rotate about the shaft.

### BRIEF DESCRIPTION OF THE DRAWINGS

The drawings, when considered in connection with the following description, are presented for the purpose of facilitating an understanding of the subject matter sought to be protected.

FIG. 1 is a cross-sectional top view and side view of a first embodiment of a vertical turbine system disclosed herein;

FIG. 2 is a top cross-sectional view of a turbine disclosed herein;

FIG. 3 is a cross-sectional view of a second embodiment of a vertical turbine system disclosed herein;

FIG. 4 is a cross-sectional top and side views of a third embodiment of a vertical turbine system disclosed herein;

FIG. 5 is a perspective view of a flexible sail disclosed herein; and

FIG. 6 is a perspective view of a turbine disclosed herein.

### DETAILED DESCRIPTION

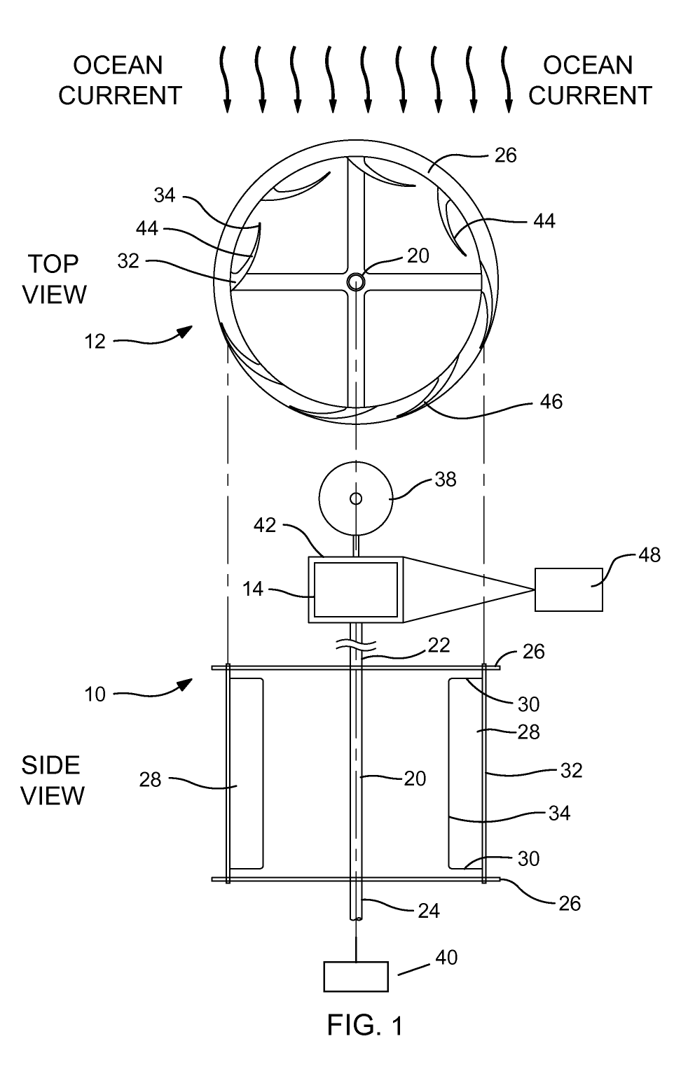

Referring to FIG. 1, shown is a cross-sectional view of the vertical turbine system 10 of the present invention. The vertical turbine system 10 includes a turbine 12, a generator 14 connected with the turbine 12 for converting rotational energy of the turbine 12 into electrical energy, anchoring means for affixing the vertical turbine system 10 to a ground surface, and torque control means for maintaining the generator 14 in a stationary position as the turbine 12 rotates. The turbine 12 rotates about a vertical rotational shaft 20 having an upper end 22 and a lower end 24, and includes a pair of oppositely disposed circular frame members 26 radially affixed to the shaft 20, a number of generally rectangular vanes 28, each having a pair of distal ends 30, a leading edge 32 and a trailing edge 34, with the vanes 28 rotatably affixed to the circular frame members 26 at the ends 30 of their leading edge 32, and means for limiting rotation of the vanes 28 to a maximum of about 40° to about 80°. The amount that rotation is limited may be fixed or variable by the user. The vanes 28 use the force imparted from the moving fluid to generate mechanical rotating power that is transmitted through the vanes 28 to the frame members 26, then to the shaft 20, and from the shaft 20 to the generator 14. The angle of attack of the vanes 28 changes to take best advantage of the fluid motion as the turbine 12 rotates. The generator 14 can be operatively connected to one of the upper end 22 and the lower end 24 of the shaft 20, either directly or through a reduction gear. The shaft 20 can be rigid or flexible, and multiple turbines 12 can share a common shaft 20.

FIG. 1 illustrates an embodiment of the present invention adapted for marine use further including a buoyancy device 38 affixed thereto, one or more anchors 40 as the anchoring means for affixing the lower end 24 of the shaft 20 to an underwater ground surface; and a water-resistant housing 42 surrounding the generator 14. The buoyancy device 38 maintains buoyancy of the entire vertical turbine system 10, and controls the level of the system relative to the water surface. The generator 14 is shown connected to the upper end 22 of the shaft 20 to facilitate maintenance and surface collection of generated electrical energy. For underwater collection, the generator 14 could be connected to the lower end 24 of the shaft 20. The generator 14 can be an AC or DC electric generator, with necessary equipment for electricity generation, conditioning and transmission to a fixed station or ship through a suitable power cable.

For marine use, the generator 14 must be held relatively stationary in the current as the turbine 12 is rotated thereby. A member 48 extending horizontally from the generator housing 42 is shown as such torque control means, maintaining the generator housing 42 in a fixed position relative to the current, and stops the torque from the shaft 20 and generator 14 from being transferred to the generator housing 42, preventing the generator housing 42 from spinning.

Shown in the top view of FIG. 1 is an embodiment of the vanes as rigid blades 44 which can be flat or, for higher efficiency, curved into an airfoil-shaped profile. The blades 44 pivot about their leading edge 32 as an axis, so that a minimal cross-section is presented when moving against the current. In order to present a maximal cross-section when moving with the current, the rotation of the blades 44 about their leading edge 32 is limited to a range of about 40° to about 80°, or about 50° to about 70°, or about 60°. For this, rotation of the blades 44 can be blocked by mechanical stops 46.

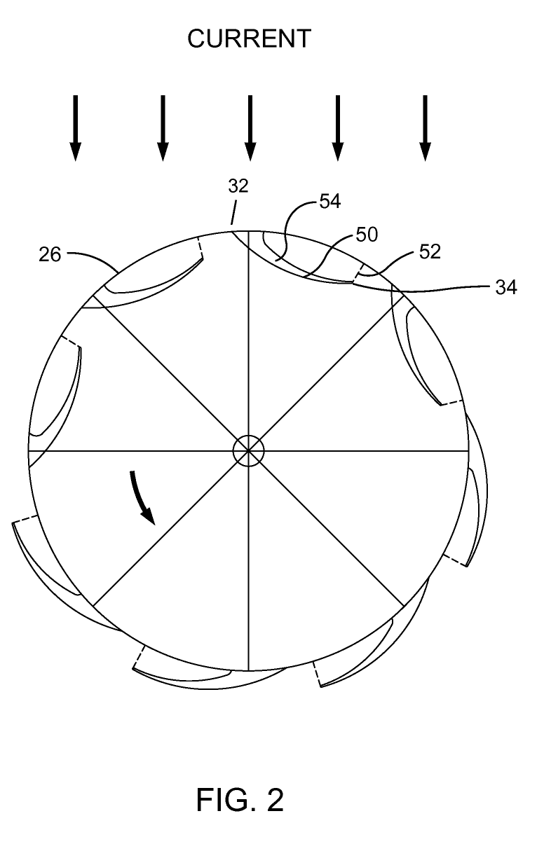

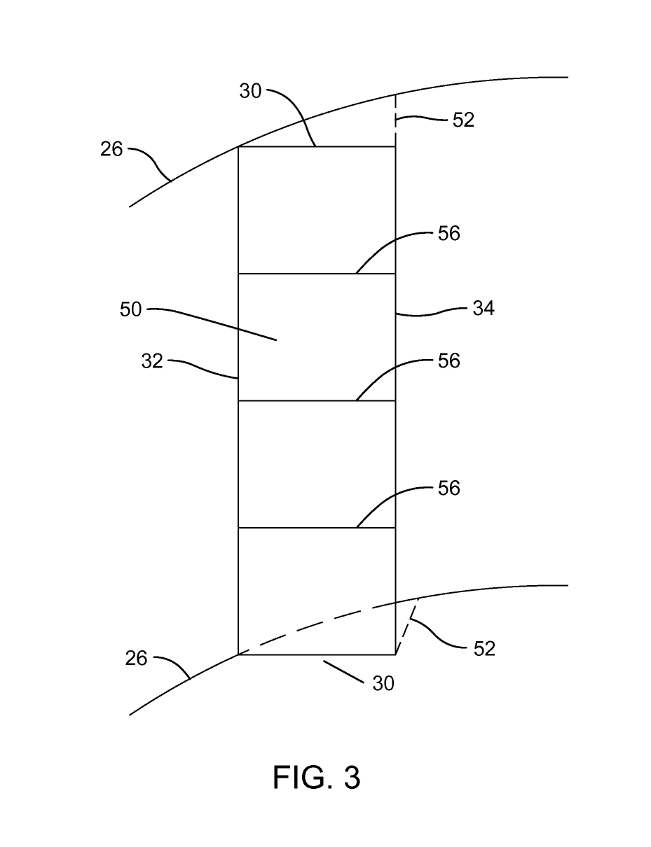

Referring now to FIG. 2 and FIG. 3, illustrated are embodiments of the invention wherein the vanes are flexible sails 50. FIG. 2 shows a cross-sectional top view of the turbine having a plurality of flexible sails 50 affixed to the circular frame members 26 along their leading edges 32. As the turbine rotates, the sails 50 pivot about their leading edge 32 as an axis, moving through an arc at their trailing edge 34, so that the sails 50 tack or jibe relative to the fluid flow direction as the turbine is rotated by the current. The movement of the trailing edge 34 of the sail 50 is limited by a tether 52. The flexible sails 50 can be stiffened by the addition of stiffening means 54 extending generally horizontally between the leading edge 32 and the trailing edge 34 of the sail 50.

As shown in FIG. 3, the stiffening means for the sails 50 can be horizontally affixed slats 56. Tethers 52 are shown connecting the trailing edge 34 on distal ends 30 of the sails 50 to the circular frame members 26. Tethers can also be used to affix the leading edge 32 of the sails 50 to the circular frame members 26. Tension between the anchoring means and the buoyancy device maintains the separation of the circular frame members 26 and tension on the ends 30 of the sails 50.

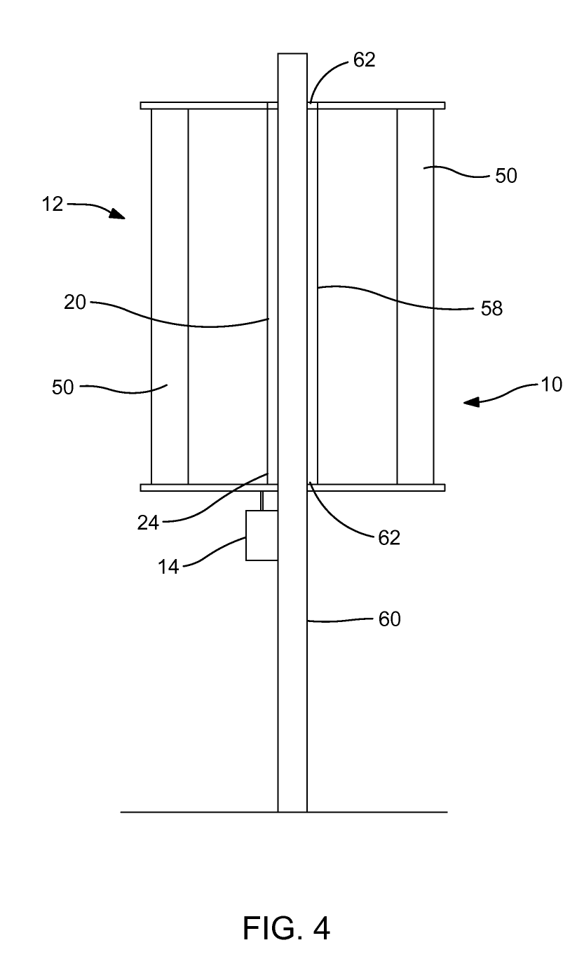

Referring now to FIG. 4, illustrated is an embodiment of the vertical turbine system 10 of the present invention adapted to land use, wherein the anchoring means includes a cylindrical bore 58 running through the center of the shaft 20, a vertical support pole 60 which is secured to the ground, with the vertical support pole 60 sized to fit within said cylindrical bore 58. The generator 14 is affixed to the lower end 24 of the shaft 20, with its attachment to the vertical support pole 60 acting to maintain the generator 14 in a stationary position as the turbine 12 rotates. Bearing means 62 allow for free rotation of the shaft 20 about the vertical support pole 60. The weight of the circular frame members 26 and the shaft 20 maintain downward tension on the sails 50.

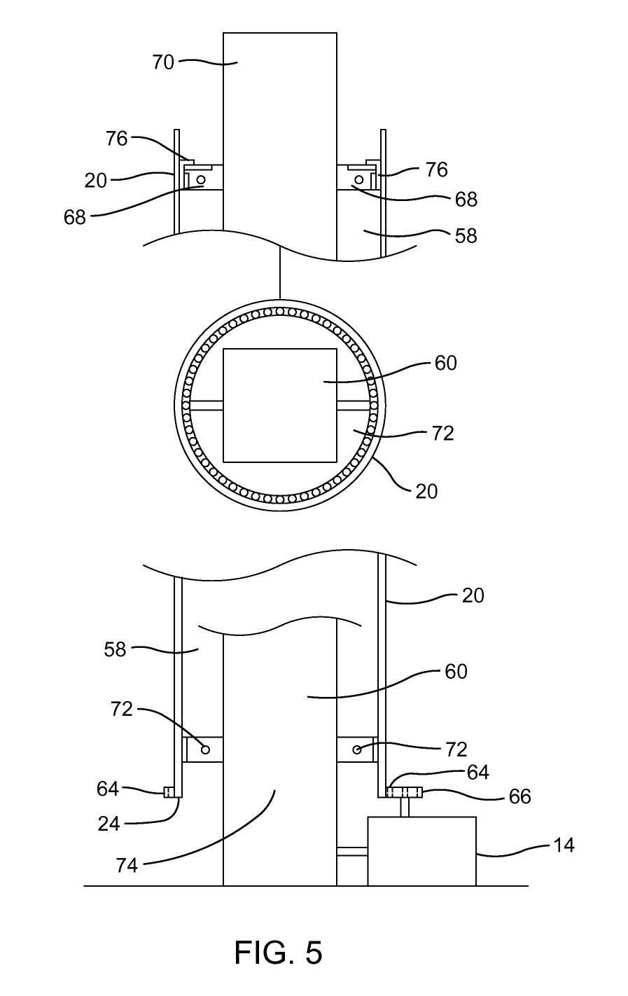

Illustrated in FIG. 5 is an embodiment of the invention wherein a ring gear 64 is affixed around the lower end 24 of the shaft 20 and matingly engages a drive gear 66 integral to the generator 14, to transmit rotational energy of the shaft 20 to the generator 14. The ring gear 64 increases the speed of the drive gear 66 rotation speed relative to the turbine rotational speed. Also shown is an embodiment of the bearing means having an upper split bearing assembly 68 affixed to an upper portion 70 of the vertical support pole 60 and a lower split bearing assembly 72 affixed to a lower portion 74 of the vertical support pole 60, to provide rolling engagement between the shaft 20 and the vertical support pole 60. The split bearing assemblies are affixed, for example bolted or screwed, to the vertical support pole 60 and are sized to fit within the cylindrical bore 58 of the shaft 20. A thrust bearing 76, can be affixed to the upper end 22 of the shaft 20 within the cylindrical bore 58 to contact the upper split bearing assembly 68 and support the weight of the turbine on the vertical support pole 60 with rolling engagement, allowing free rotation of the turbine about the vertical support pole 60.

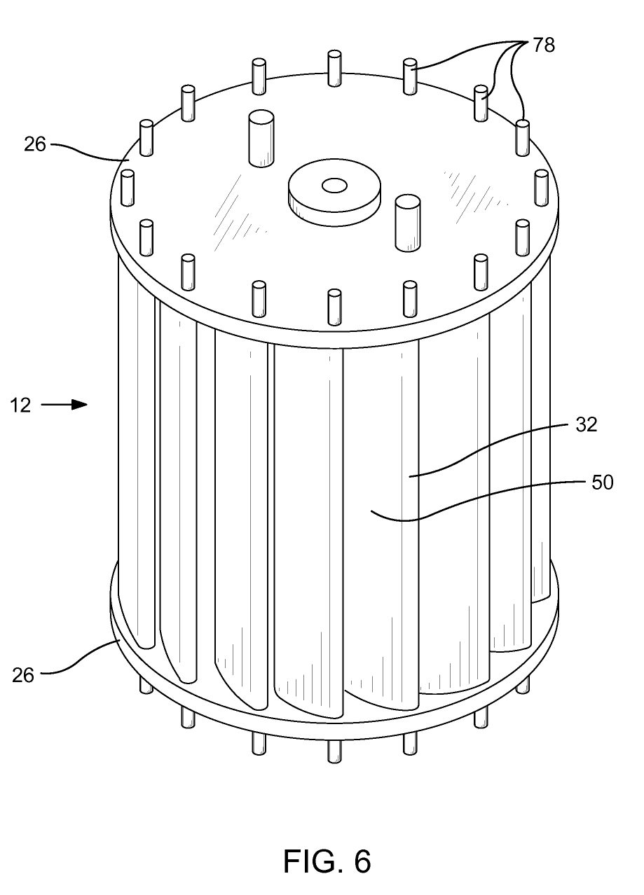

Referring now to FIG. 6, shown is an embodiment the turbine 12 wherein a plurality of vertical rods 78 interconnect the circular frame members 26 and form the leading edges 32 of the flexible sails 50.

The vertical turbine system of the present invention, when used in marine environments, may be used for power generation from tidal currents, which flow in two directions, with varying velocities. Alternately, the vertical turbine system may be used for stable ocean currents, such as those between islands, or the Gulf Stream. Smaller models may be used in tidal flows to generate auxiliary power for moored vessels. The vertical ocean turbine may be used to develop power for a wide variety of equipment, including electric power generation. Single or multiple vertical ocean turbines may be mounted on a single flexible shaft to an electric generator near the surface, with a buoyancy device holding the unit near the surface, and an anchor holding the turbine in place and maintaining the vertical configuration. This would allow a ship to assemble and deploy multiple turbine sections vertically, with one generator.

The vertical turbine system of the present invention, when used with wind on land, may be used for small to large power generation applications, including wind power farms, commercial applications, residential housing applications or roadway lighting applications.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A vertical turbine system comprising:
a turbine including:
(a) a vertical rotational shaft having an upper end and a lower end,
(b) a pair of oppositely disposed circular frame members, each of said circular frame members radially affixed to said shaft,
(c) a plurality of vanes, each of said plurality of vanes having a generally rectangular profile, a pair of distal ends, a leading edge and a trailing edge, each of said plurality of vanes rotatably affixed to said circular frame members at said ends of said leading edge, and
(d) means for limiting rotation of said plurality of vanes to a maximum of about 40° to about 80°;
a generator operatively connected to one of said upper and lower ends of said shaft for converting rotational energy of said shaft into electrical energy;
anchoring means for affixing said lower end of said shaft to a ground surface; and
torque control means for maintaining said generator in a generally stationary position as said turbine rotates about said shaft.

2. The system of claim 1, further comprising:
a buoyancy device affixed to said system;
one or more anchors as said anchoring means for affixing said lower end of said shaft to an underwater ground surface; and
a water-resistant housing surrounding said generator.

3. The system of claim 2, wherein:
said generator is operatively connected to said upper end of said shaft;
each of said plurality of vanes is a rigid blade having a shape selected from flat and airfoil-shaped;
said means for limiting rotation of said plurality of vanes includes a plurality of mechanical stops; and
said torque control means includes a member extending horizontally from said generator housing.

4. The system of claim 2, wherein:
said generator is operatively connected to said upper end of said shaft;
each of said plurality of vanes is a flexible sail;
said means for limiting rotation of said plurality of vanes includes a tether connecting said trailing edge of each said end of said vanes to one of said pair of circular frame members; and
said torque control means includes a member extending horizontally from said generator housing.

5. The system of claim 2, further comprising a plurality of said turbines having a common shaft.

6. The system of claim 5, wherein said shaft is a flexible shaft.

7. The system of claim 4, wherein said tethers limit rotation of each of said plurality of flexible sails to a maximum of about 50° to about 70°.

8. The system of claim 4, wherein said leading edge of said sail comprises a vertical rod interconnecting said circular frame members.

9. The system of claim 1, wherein said anchoring means comprises:
a cylindrical bore through the center of said shaft;
a vertical support pole securable to a terrestrial ground surface, said vertical support pole sized to fit within said cylindrical bore; and
bearing means for allowing free rotation of said shaft about said vertical support pole.

10. The system of claim 9, wherein:
said generator is operatively connected to said lower end of said shaft;
each of said plurality of vanes is a flexible sail;
said means for limiting rotation of said plurality of vanes includes a tether connecting said trailing edge of each said end of said vanes to one of said pair of circular frame members; and
said generator is fixedly attached to said vertical support pole as said torque control means.

11. The system of claim 10, wherein:
said system further comprises:
(a) a ring gear affixed to said lower end of said shaft, and
(b) a drive gear integral to said generator, said drive gear sized to matingly engage said ring gear to transmit rotational energy of said shaft to said generator; and
said bearing means includes:
(a) an upper split bearing assembly affixed to an upper portion of said vertical support pole, said upper split bearing assembly providing rolling engagement between said upper end of said shaft and said vertical support pole,
(b) a lower split bearing assembly affixed to a lower portion of said vertical support pole, said lower split bearing assembly providing rolling engagement between said lower end of said shaft and said vertical support pole, and
(c) a thrust bearing to support said turbine on said vertical support pole with rolling engagement.

12. The system of claim 11, wherein said thrust bearing is affixed to said upper end of said shaft within said cylindrical bore to contact said upper support bearing assembly with rolling engagement.

13. The system of claim 10, wherein each of said flexible sails further comprises stiffening means.

14. The system of claim 13, wherein said stiffening means comprises a plurality of slats horizontally affixed to said flexible sails.

15. The system of claim 10, further comprising a plurality of said turbines having a common shaft.

16. The system of claim 10, wherein said tethers limit rotation of each of said plurality of sails to a maximum of about 50° to about 70°.

17. A method of generating electrical energy from a moving fluid stream comprising the steps:
providing a vertical turbine system including:
(a) a turbine including:
(i) a vertical rotational shaft having an upper end and a lower end,
(ii) a pair of oppositely disposed circular frame members, each of said circular frame members radially affixed to said shaft,
(iii) a plurality of vanes, each of said plurality of vanes having a generally rectangular profile, a pair of distal ends, a leading edge and a trailing edge, each of said plurality of vanes rotatably affixed to said circular frame members at said ends of said leading edge, and
(iv) means for limiting rotation of said plurality of vanes to a maximum of about 600,
(b) a generator operatively connected to one of said upper and lower ends of said shaft for converting rotational energy of said shaft into electrical energy,
(c) anchoring means for affixing said lower end of said shaft to a ground surface, and
(d) torque control means for maintaining said generator in a generally stationary position as said turbine rotates about said shaft; and
anchoring said vertical turbine system to a ground surface with said turbine in a moving fluid stream such that the moving fluid stream causes said turbine to rotate about said shaft.

18. The method of claim 17 for generating electrical energy from a moving stream of water, wherein:
said vertical turbine system further includes:
(a) a buoyancy device affixed to said system,
(b) one or more anchors as said anchoring means for affixing said lower end of said shaft to an underwater ground surface, and
(c) a water-resistant housing surrounding said generator;
said generator is operatively connected to said upper end of said shaft;
each of said plurality of vanes is a rigid blade having a shape selected from flat and airfoil-shaped;
said means for limiting rotation of said plurality of vanes includes a plurality of mechanical stops; and
said torque control means includes a member extending horizontally from said generator housing.

19. The method of claim 17 for generating electricity from wind, wherein:
said anchoring means includes:
(a) a cylindrical bore through the center of said shaft,
(b) a vertical support pole securable to a terrestrial ground surface, said vertical support pole sized to fit within said cylindrical bore, and
(c) bearing means for allowing free rotation of said shaft about said vertical support pole;
said generator is operatively connected to said lower end of said shaft by means of:
(a) a ring gear affixed to said lower end of said shaft, and
(b) a drive gear integral to said generator, said drive gear sized to matingly engage said ring gear to transmit rotational energy of said shaft to said generator;
each of said plurality of vanes is a flexible sail;
said means for limiting rotation of said plurality of vanes includes a tether connecting said trailing edge of each said end of said vanes to one of said pair of circular frame members; and
said generator is fixedly attached to said vertical support pole as said torque control means.

20. A vertical turbine comprising:
a vertical rotational shaft having an upper end and a lower end;
a pair of oppositely disposed circular frame members, each of said circular frame members radially affixed to said shaft;
a plurality of vanes, each of said plurality of vanes having a generally rectangular profile, a pair of distal ends, a leading edge and a trailing edge, each of said plurality of vanes rotatably affixed to said circular frame members at said ends of said leading edge; and
means for limiting rotation of said plurality of vanes to a maximum of about 40° to about 80°.

21. The turbine of claim 20, wherein:
each of said plurality of vanes is a rigid blade having a shape selected from flat and airfoil-shaped; and
said means for limiting rotation of said plurality of vanes includes a plurality of mechanical stops.

22. The turbine of claim 20, wherein:
each of said plurality of vanes is a flexible sail; and
said means for limiting rotation of said plurality of vanes includes a tether connecting said trailing edge of each said end of said vanes to one of said pair of circular frame members.

23. The turbine of claim 22, wherein said leading edge of said sail comprises a vertical rod interconnecting said circular frame members.
